(19) United States
(12) Patent Application Publication
(10) Pub. No.: US 2023/0305119 A1
(43) Pub. Date: Sep. 28, 2023

(54) TECHNIQUES TO SELECT MULTIPLE RETURNS IN FREQUENCY MODULATED CONTINUOUS WAVE LIDAR SYSTEMS

(71) Applicant: AEVA, INC., Mountain View, CA (US)

(72) Inventors: Jose Krause Perin, Mountain View, CA (US); Kumar Bhargav Viswanatha, Santa Clara, CA (US); Rajendra Tushar Moorti, Mountain View, CA (US); Mina Rezk, Haymarket, VA (US); Sajith Mohan Chakkedath, Santa Clara, CA (US)

(21) Appl. No.: 17/703,876

(22) Filed: Mar. 24, 2022

(51) Int. Cl. G01S 7/4865; G01S 7/481; G01S 7/295; G01S 7/28

(52) U.S. Cl. CPC G01S 7/4865; G01S 7/4811; G01S 7/295; G01S 7/2806

(57) ABSTRACT

A method to select multiple returns in a light detection and ranging (LIDAR) system includes thresholding a frequency domain waveform to identify a number of peaks above a threshold level. After thresholding, a primary peak selection is applied to identify a primary peak. After identifying a primary peak, a secondary peak selection is applied to a portion of the frequency domain waveform outside a guard-band area to identify a secondary peak.

### FIELD OF INVENTION

The present disclosure is related to light detection and ranging (LIDAR) systems.

### BACKGROUND

Conventional Frequency-Modulated Continuous-Wave (FMCW) LIDAR systems include several possible sources of noise or phase impairments such as laser phase noise, circuitry phase noise, flicker noise, drift over temperature/weather, and chirp rate offsets. These impairments can make detection of secondary peaks challenging, increase false alarm and range/velocity bias, and increase the error in estimated target range/velocity.

### SUMMARY

The present disclosure describes various embodiments of LIDAR systems and methods that, among other things, facilitate selecting multiple returns or peaks. One embodiment of the present disclosure relates to a light detection and ranging (LIDAR) system comprising: an optical beam source to transmit a first optical beam to a target, a photo detector to receive a return from the target, and signal processing circuitry. The signal processing circuitry is to threshold a frequency domain waveform to identify a plurality of peaks above a threshold level corresponding to a plurality of targets, apply a primary peak selection to the frequency domain waveform to identify a primary peak from the plurality of peaks, apply a secondary peak selection to a portion of the frequency domain waveform outside a guard-band area to identify a secondary peak from the plurality of peaks that is outside the guard-band area, and determine range and velocity information corresponding to the primary peak and secondary peak.

Another embodiment relates to a method of selecting multiple returns in a light detection and ranging (LIDAR) system. The method comprises thresholding a frequency domain waveform to identify a plurality of peaks above a threshold level corresponding to a plurality of targets and applying a primary peak selection to the frequency domain waveform to identify a primary peak from the plurality of peaks. The method further comprises applying a secondary peak selection to a portion of the frequency domain waveform outside a guard-band area to identify a secondary peak from the plurality of peaks that is outside the guard-band area. The method further comprises determining range and velocity information corresponding to the primary peak and secondary peak.

Other embodiments of the present disclosure relate to a light detection and ranging (LIDAR) system comprising: an optical beam source to transmit a first optical beam to a target, a photo detector to receive a return from the target, and signal processing circuitry including a memory storing instructions which, when executed, cause the signal processing circuitry to: threshold a frequency domain waveform to identify a plurality of peaks above a threshold level corresponding to a plurality of targets and apply a primary peak selection to the frequency domain waveform to identify a primary peak from the plurality of peaks. The signal processing circuitry is further to apply a secondary peak selection to a portion of the frequency domain waveform outside a guard-band area to identify a secondary peak from the plurality of peaks that is outside the guard-band area and determine range and velocity information corresponding to the primary peak and secondary peak; and feed the range and velocity information to a point cloud.

### BRIEF DESCRIPTION OF THE DRAWINGS

For a more complete understanding of the various examples, reference is now made to the following detailed description taken in connection with the accompanying drawings in which like identifiers correspond to like elements.

FIG. 1 illustrates an example LIDAR system according to embodiments of the present disclosure.

FIG. 2 is a time-frequency diagram illustrating how LIDAR waveforms are detected and processed according to embodiments of the present disclosure.

FIG. 3 is a block diagram of an example LIDAR system, according to embodiments of the present disclosure.

FIGS. 4A-4C illustrate a number of frequency domain waveforms including a true target and noise event, according to embodiments of the present disclosure.

FIG. 5 illustrates a method for automatically adjusting a detection threshold, according to embodiments of the present disclosure.

FIGS. 6A-6B illustrate techniques for selecting multiple peaks using a thresholding metric and peak selection metric, according to embodiments of the present disclosure.

FIG. 7 illustrates examples of additional peak selection strategies, according to embodiments of the present disclosure.

FIG. 8 illustrates an example guard band intended to avoid multiple detections of the same target, according to embodiments of the present disclosure.

FIG. 9 illustrates an example static guard band, according to embodiments of the present disclosure.

FIG. 10 illustrates an example dynamic guard band, according to embodiments of the present disclosure.

FIG. 11 illustrates an example roll-off peak estimator, according to embodiments of the present disclosure.

FIG. 12 illustrates an example segment based peak selection strategy, according to embodiments of the present disclosure.

FIG. 13 illustrates an example of a multi-pass algorithm used to select three peaks, according to embodiments of the present disclosure.

FIG. 14 illustrates an example sub-band peak selection process, according to embodiments of the present disclosure.

FIG. 15 illustrates a feature of an example sub-band peak selection algorithm, according to embodiments of the present disclosure.

FIG. 16 illustrates another example sub-band peak selection process, according to embodiments of the present disclosure.

FIG. 17 is a flow diagram of an example method to select multiple peaks within a LIDAR system, according to an embodiment of the present disclosure.

### DETAILED DESCRIPTION

The present disclosure describes various examples of LIDAR systems and methods to detect multiple returns in FMCW LIDAR systems. According to some embodiments, the described LIDAR system may be implemented in any sensing market, such as, but not limited to, transportation, manufacturing, metrology, medical, augmented reality, virtual reality, and security systems. According to some embodiments, the described LIDAR system is implemented as part of a front-end of frequency modulated continuous-wave (FMCW) device that assists with spatial awareness for automated driver assist systems, or self-driving vehicles.

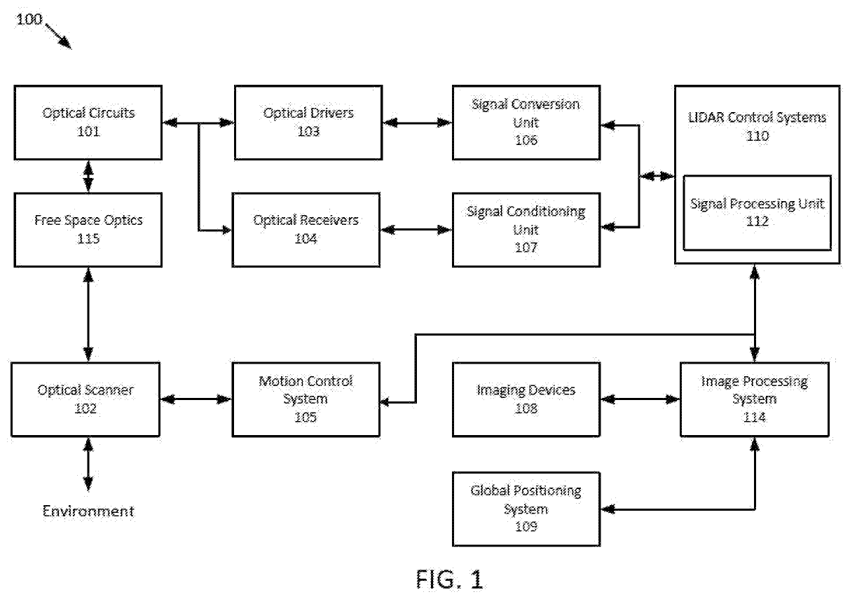

FIG. 1 illustrates a LIDAR system 100 according to example implementations of the present disclosure. The LIDAR system 100 includes one or more of each of a number of components, but may include fewer or additional components than shown in FIG. 1. One or more of the components depicted in FIG. 1 can be implemented on a photonics chip, according to some embodiments. As shown, the LIDAR system 100 includes optical circuits 101 implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a DSP. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the return signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

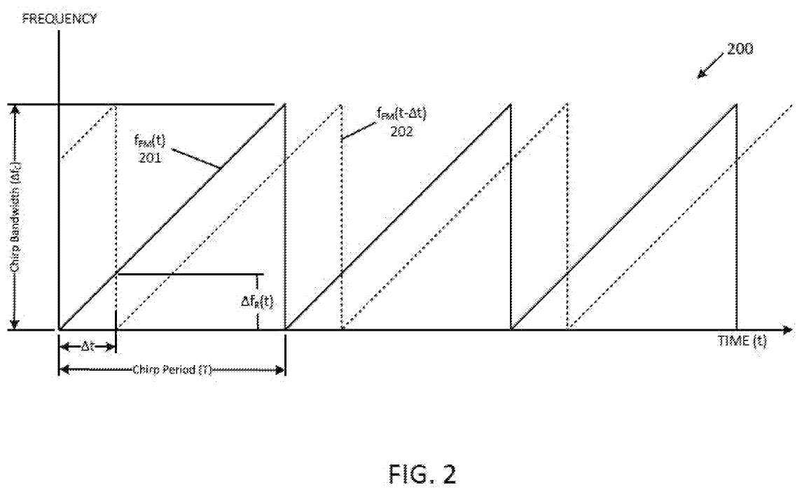

FIG. 2 is a time-frequency diagram 200 of an FMCW scanning signal 201 that can be used by a LIDAR system, such as system 100, to scan a target environment according to some embodiments. In one example, the scanning waveform 201, labeled as fFM(t), is a sawtooth waveform (sawtooth “chirp”) with a chirp bandwidth ΔfC and a chirp period TC. The slope of the sawtooth is given as k=(ΔfC/TC). FIG. 2 also depicts target return signal 202 according to some embodiments. Target return signal 202, labeled as fFM(t−Δt), is a time-delayed version of the scanning signal 201, where Δt is the round trip time to and from a target illuminated by scanning signal 201. The round trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range dependent difference frequency (“beat frequency”) ΔfR(t) is generated. The beat frequency ΔfR(t) is linearly related to the time delay Δt by the slope of the sawtooth k. That is, ΔfR(t)=kΔt. Since the target range R is proportional to Δt, the target range R can be calculated as R=(c/2)(ΔfR(t)/k). That is, the range R is linearly related to the beat frequency ΔfR(t). The beat frequency ΔfR(t) can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100. It should be noted that the target return signal 202 will, in general, also include a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (ΔfRmax) is 500 megahertz. This limit in turn determines the maximum range of the system as Rmax=(c/2)(ΔfRmax/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

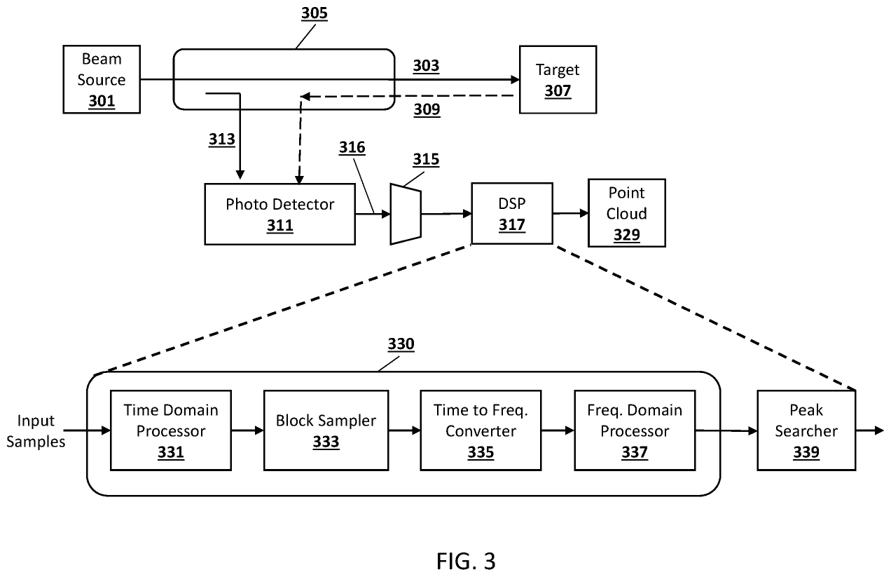

FIG. 3 is a block diagram of an example LIDAR system, according to embodiments of the present disclosure. In one example embodiment, the system includes a beam source 301, such as a FMCW laser source. The target arm includes a number of optical components (e.g. lenses or filters) 305 through which the scanning signal 303 can pass on its way to a target 307. The return signal 309 can be reflected from the target 307 and directed to a photo detector 311. From the photo detector 311, a digitally sampled target signal 316 then passes to a target ADC 315, and then to the digital signal processor (DSP) 317, and then to a point cloud 329. In some embodiments, the DSP 317 can mitigate impairments and condition the signal for peak search 339. The DSP 317 may include a frontend processor 330, comprising a time domain processor 331, block samplers 333 (to generate block samples for a Fourier transform), time to frequency converter 335, and frequency domain processor 337, according to some embodiments. A peak searcher 339 can receive a frequency domain waveform and find the frequency binds that have the highest likelihood of corresponding to a true target.

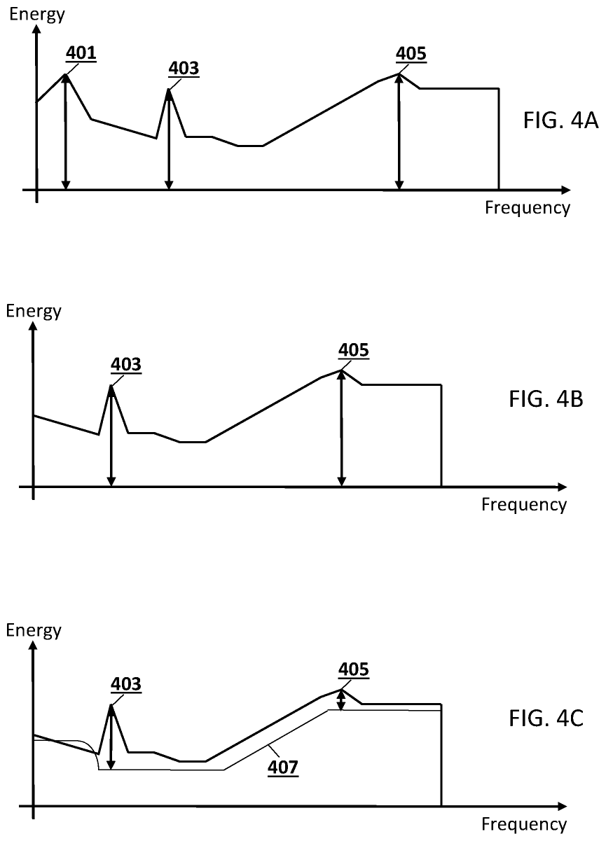

FIGS. 4A-4C illustrate a number of frequency domain waveforms including a true target and noise event, according to embodiments of the present disclosure. As shown in FIG. 4A, a frequency domain waveform that includes a true target 403 may be corrupted by several impairments, including electrical interference 401 or internal reflections that can create a false target, as well as multiple types of noise events 405, including shot noise, thermal noise, quantization noise, phase noise, etc. The noise sources can affect the accuracy of detection, and may not be constant across frequency. A goal of peak search 339 is to accurately detect a true target 403 (high detection probability), while keeping false detections low.

FIG. 4B illustrates a frequency domain waveform with no noise calibration or compensation, while FIG. 4C illustrates the same frequency domain waveform with noise calibration, according to embodiments of the present disclosure. In the waveform shown in FIG. 4B, the noise event 405 has a higher energy than the true target 403.

The embodiment shown in FIG. 4C compares the frequency domain waveform against an estimated noise level 407 in order to determine a likelihood metric relative to the noise level 407, thus making the detector less susceptible to noise events. In FIG. 4C the true target 403 has a higher likelihood than the noise event 405. Typical likelihood metrics can include signal-to-noise ratio (SNR), in some embodiments.

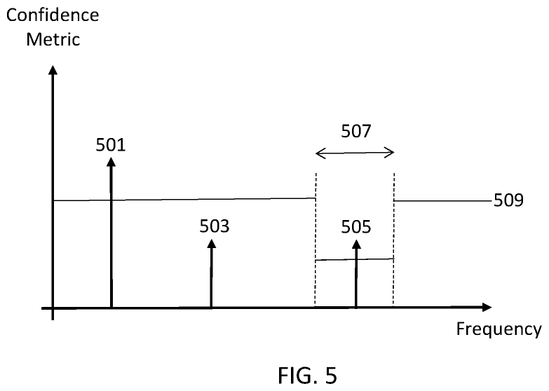

FIG. 5 illustrates a method for automatically adjusting a detection threshold, according to embodiments of the present disclosure. In this embodiment, a strong target 501, false alarm 503, and a weak target 505 are each detected. However, only the strong target 501 is higher than the effective threshold value 509. According to this embodiment, the location of the weak target 505 can be estimated based on previous detections or point cloud processing (target identification, tracking, etc.). Based on the expected location of the weak target, the threshold can be adjusted in order to favor detections within a predicted target band 507. Thus, although the weak target 505 has a similar confidence metric as the false alarm 503, the threshold is lowered within the predicted target band 507 in order to detect the weak target 505.

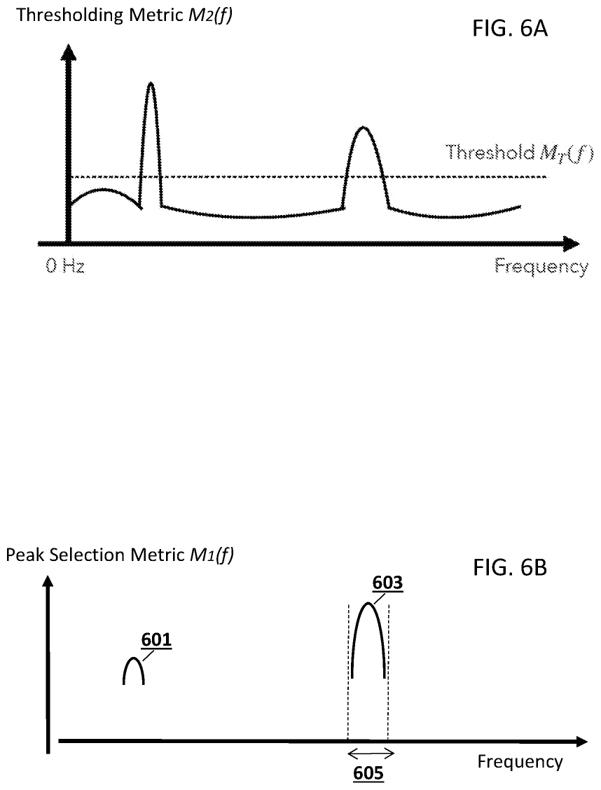

FIGS. 6A-6B illustrate techniques for selecting multiple peaks using a thresholding metric and peak selection metric, according to embodiments of the present disclosure. In FIG. 6A, a thresholding metric M₂(f) is applied to the frequency domain waveform in order to identify any peaks above the threshold value M_{T}(f). In FIG. 6B, a peak selection metric M₁(f) is applied to the frequencies above the threshold value identified in FIG. 6A.

In one example embodiment, the thresholding metric used can be SNR, while the peak selection metric is intensity. In such an embodiment, SNR is used to eliminate all frequencies below the threshold value M_{T}(f), and then the primary peak 603 is selected as the highest intensity peak for the frequencies that passed the thresholding operation. After selecting a primary peak 603, a secondary peak 601 can be selected using the same peak selection metric, or a different metric. For example, the primary peak can be selected based on intensity with thresholding using SNR, while the secondary peak can be selected based on SNR and with thresholding using SNR. For third or more returns, the search can exclude all the frequencies corresponding to peaks that have already been selected. In order to prevent detecting side lobes of the primary peak, a secondary peak search could be performed on all frequencies that are outside of a guard band 605 for the primary peak 603.

In one example embodiment, the peak selection operation could be formulated as the following optimization where different likelihood metrics are used for thresholding M₂(f) and peak selection M₁(f):

$$p = arg {max}_{f} {M}_{1} ( f )$$

Subject to M₂(f)≥M_{T}(f), where M_{T}(f) is the threshold required. Similarly, the multiple peak calculation could be determined based on the same metrics:

$$p = arg {max}_{f ∉ {P}_{1}} {M}_{1} ( f )$$

Subject to M₂(f)≥M_{T}(f), where f∉P₁ indicates that the search is performed on all frequencies except the ones that are part of the primary peak P₁. In practice, P₁ can be defined based on a guard band, as detailed below.

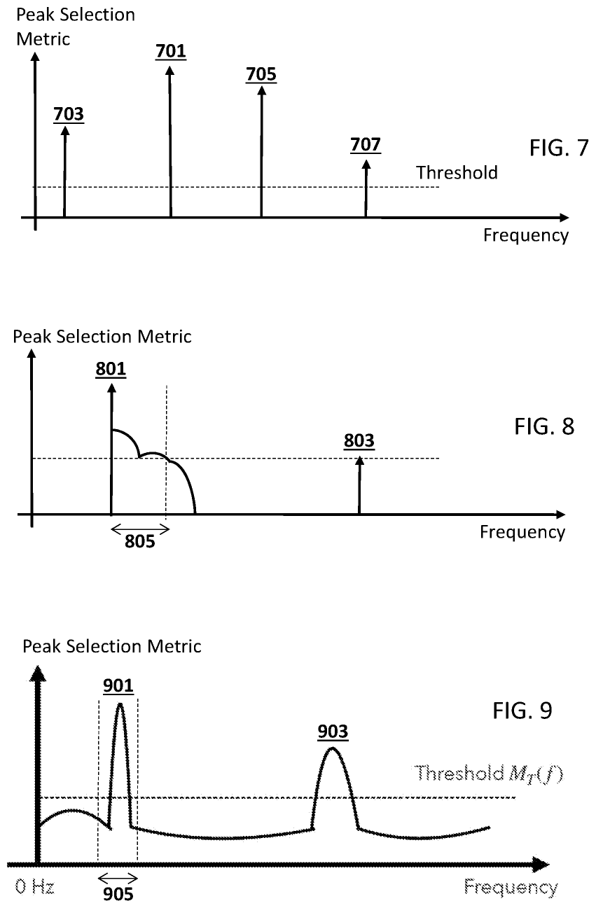

FIG. 7 illustrates examples of additional peak selection strategies, according to embodiments of the present disclosure. In this embodiment, a primary peak 701 has been identified, and there are three additional peaks that may be selected. According to one embodiment, the strongest peak 705 with the second highest peak selection metric may be selected as the secondary peak, regardless of its location (frequency). According to this peak selection strategy, the returns are detected based on their peak selection metric value.

According to another embodiment, a highest frequency peak 707 with the highest-frequency detection above a given threshold can be selected as the secondary peak. This peak corresponds to the farthest peak detected from the sensors. This peak selection strategy is biased towards detections to targets that appear farther away in range, and may favor true targets in the presence of fog or other sparse targets (e.g., chain link fences). If the farthest peak is desired, the process can begin by searching the highest frequency detections working backward, and stop after the first peak is encountered, since this would correspond to the highest-frequency detection outside of the primary peak.

According to another embodiment, the lowest frequency peak 701 with the lowest-frequency detection above a given threshold can be selected as the secondary peak. This peak corresponds to the closest peak detected from the sensors. This peak selection strategy is biased towards detections to targets appearing closest to the sensor in range, and may be useful to detect occlusions or blockages on the sensor window, or other close-range objects. If the closest peak is desired, the process can begin by searching the lowest frequency detections and stop after the first peak is encountered, since this would correspond to the lowest-frequency detection outside of the primary peak.

FIG. 8 illustrates an example guard band intended to avoid multiple detections of the same target, according to embodiments of the present disclosure. In this embodiment, a strong target 801 includes a number of large side lobes whose magnitude is higher than the weak target 803. Thus, a minimum guard band around the strong target 801 should be respected so that the second peak that maximizes the peak selection metric is an independent target, rather than merely a side lobe of the strong target. In this embodiment, the half-guard-band 805 is shown to the right of the strong target 801 in order to prevent high-intensity side lobes of the strong target from being selected as a secondary peak. Such an approach may be useful when highly reflective targets, such as reflective road signs, generate large side lobes.

FIG. 9 illustrates an example static guard band, according to embodiments of the present disclosure. In this embodiment, a primary peak 901 has been identified, and a static guard band 905 is used to ignore detections around the primary peak 901 when searching for the secondary peak 903. A small guard band may not work well for strong targets that are broad in frequency. On the other hand, setting the guard band too wide may result in losing resolution between nearby targets.

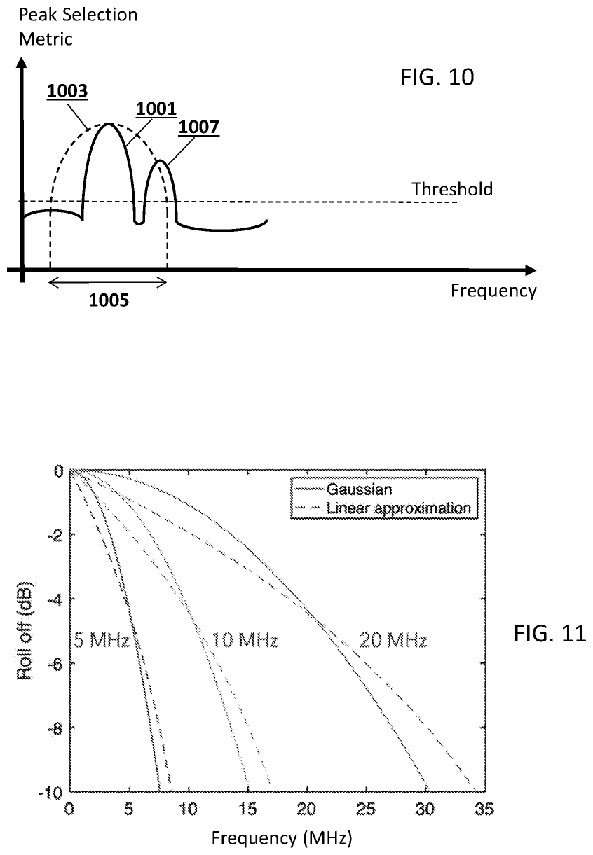

FIG. 10 illustrates an example dynamic guard band, according to embodiments of the present disclosure. For a dynamic guard band, the guard band bandwidth can be adjusted based on peak properties such as SNR, intensity, or frequency. In the example shown in FIG. 10, a model for the expected peak roll-off 1003 is used, which models how the magnitude is expected to decay away from a primary peak 1001. In this embodiment, a guard band 1005 is set around the primary peak 1001 and defined as the frequency band for which the expected roll-off is above the peak detection threshold. Detections whose magnitude are above the expected roll-off 1003 may be treated as independent detections, such as peak 1007, even though they may fall within the guard band 1005. This allows for higher resolution of detecting peaks that appear near each other in frequency.

FIG. 11 illustrates an example roll-off peak estimator, according to embodiments of the present disclosure. In this example, the expected peak roll-off can be determined based on a Gaussian shape with bandwidths of 5, 10, and 20 MHz. In some embodiments, other distributions can be used, such as other distributions that depend on the intensity and frequency of the target detected.

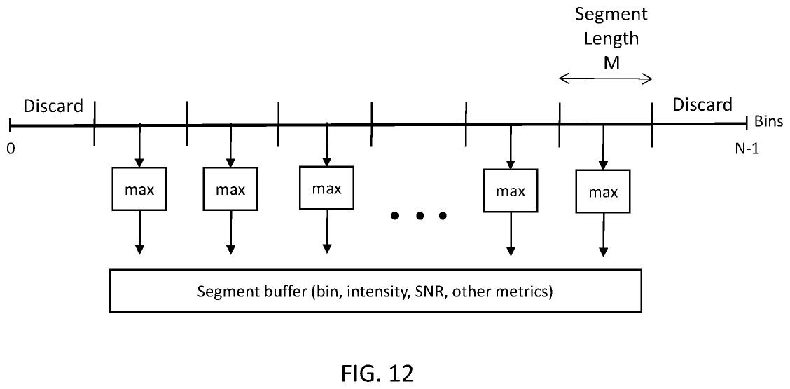

FIG. 12 illustrates an example segment based peak selection strategy, according to embodiments of the present disclosure. According to the strategies described so far, multiple passes may be needed in the frequency waveform in order to select peaks. For instance, one iteration or pass may be performed to select a primary peak, and another pass to select a secondary peak, and so forth. This requires storing the frequency domain waveform for the entire duration of the peak selection process. In practice, this corresponds to storing intensity, SNR, or other metrics used for peak selection for all frequency bins, as well as state variables such as previous peaks, guard bands, etc. To reduce the memory utilization requirement, the frequency waveform can be divided into segments, and only stored the metrics for one representative per segment. FIG. 12 illustrates a frequency waveform of N bins divided into N/M segments of length M, where only the highest detection within each segment is stored. Increasing M reduces the memory requirement but may also limit the granularity, as the peak guard band would have to be respected in terms of segments rather than bins. For example, if a primary peak is detected at segment 10, segments 9 and 11 can be ignored when searching for secondary peaks.

In one embodiment, the techniques described in FIG. 12 function as a down-sampling process, such that the thresholding, primary peak selection, and secondary peak selection are performed on a down-sampled set of frequencies. These frequencies correspond to the maximum frequencies within each of the segments.

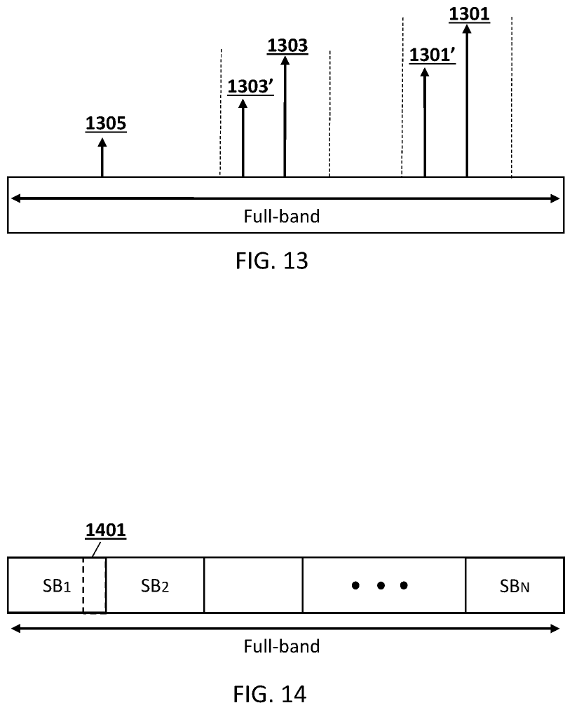

FIG. 13 illustrates an example of a multi-pass algorithm used to select three peaks, according to embodiments of the present disclosure. In this example, each pass through the full-band picks one return by finding the maximum. After selecting primary peak 1301, a guard band around that peak is applied, thus eliminating peak 1301′, and the remaining bins are used for the next pass. In the second pass, peak 1303 is selected as the secondary peak, and a guard band is applied to eliminate peak 1303′. In the third pass, peak 1305 is selected as the tertiary peak. In the case of P returns, P passes are required, and the whole full-band is needed in memory for all passes, which can cause delays in output introduced for each pass. Example pseudo code for this algorithm includes:

```
present_input = full_band; % initialize input with full-band
for i = 1 : kReturnCount
  [peak(i), bins(i)] = peak_picker(present_input);
  present_input = remove_guard_band(present_input);
end
```

FIG. 14 illustrates an example sub-band peak selection process, according to embodiments of the present disclosure. In this embodiment, the full-band is divided into N sub-bands, and the process works on one sub-band of frequencies at a time and repeats over all subsets. The multi-pass algorithm described in FIG. 13 can be applied to each sub-band sequentially. In one embodiment, when processing on the final sub-band is over, the final peaks for the whole band are ready. Each sub-band processing uses its sub-band bins, as well as a few guard bands 1401 of bins from the previous sub-band. For example, for processing the second sub-band SB₂, SB₂ and the area 1401 are used. The size of region 1401 depends on both the number of returns and the guard band size. This strategy avoids multiple passes over the full-band, decreases buffer memory requirements, and can support implementations where a sub-band becomes available for one point at a time. Example pseudo code for this algorithm includes:

```
present_input = sub_band(1, :); % initialize input with first sub-band
for i = 1 : kSubBandsCount
  [peaks, bins] = multiple_pass_peak_picker(present_input);
  next_input = sub_band(i+1, :); % get next sub_band
  present_input = update_input(next_input, present_input, peaks, bins);
end
```

In an embodiment, the technique disclosed in FIG. 14 avoids multiple passes over the full-band, decreases buffer memory requirements, and can support implementations where a sub-band becomes available for one point at a time. For picking P peaks from a total of N bins divided into sub-bands of M bins each, and for a guard band size of G, only M+(P−1)*G bins are needed in memory. In comparison, for a full-band algorithm the full N bins are needed in memory. Memory savings increase with decreasing values of M, P, and G, and vice versa.

The techniques described in FIG. 14 allow for all peaks to be detected within a single pass through the frequency domain waveform. In one embodiment, the frequency domain waveform is divided into sub-bands, and multiple passes can be performed at the sub-band level to apply a threshold value and select primary and secondary peaks. Once peaks have been selected at the sub-band level, the process can move on to the next sub-band and discard the already-processed sub-band, thus saving memory. Although multiple passes may be performed at the sub-band level, all the peaks can be selected with only a single pass through the frequency domain waveform.

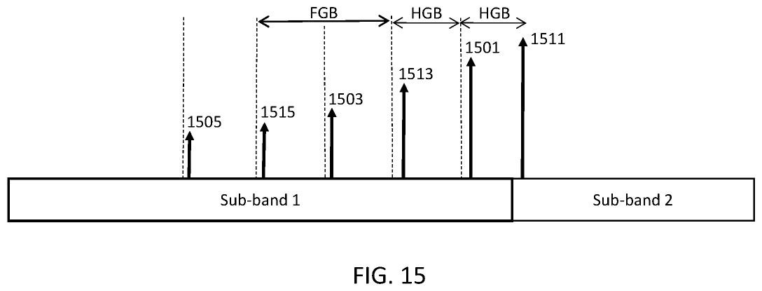

FIG. 15 illustrates a feature of an example sub-band peak selection algorithm, according to embodiments of the present disclosure. According to this embodiment, sub-band 1 is searched, and a primary peak 1501 is identified, as well as secondary peak 1503 and tertiary peak 1505. Peak 1513 is ignored initially, as it falls within the full guard band (FGB) of primary peak 1501. Similarly, peak 1515 is ignored initially, as it falls within the FGB of secondary peak 1503. Once the process proceeds to sub-band 2, however, a new primary peak 1511 is identified. Since peak 1511>1501, peak 1511 becomes the new primary peak, and peak 1501 is now ignored because it falls within the guard band of new primary peak 1511. Removing peak 1501 then brings peak 1513, which was originally ignored, back into contention as the secondary peak. Since peak 1513>1503, it now becomes the new secondary peak. Because peak 1503 is within the guard band of peak 1513, it is now removed. Extending the same logic, peak 1515 becomes the new third peak. Thus, in order to recover the originally ignored peaks 1513 and 1515, the process should store 2 guard bands (P−1) worth of the previous sub-band.

In an example where three peaks are selected (P=3), let N=1024, M=64, and G=16. The memory requirements for such an operation would be: 64+2*16=96. This is a significant memory saving compared to the full-band operation which would require 1024. Specifically, the memory saving in such an example would be: 1024−96=928.

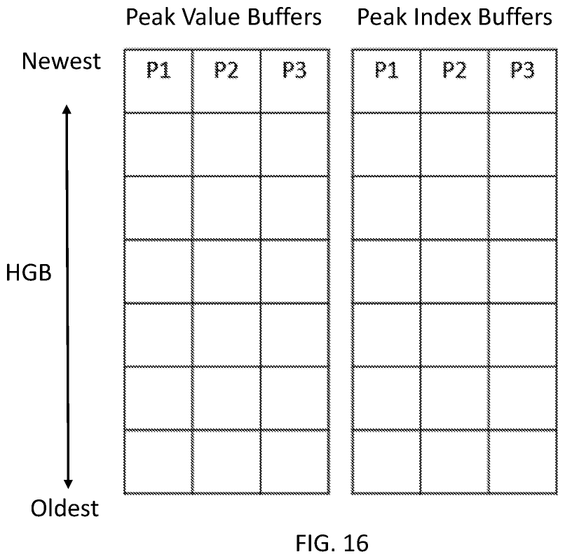

FIG. 16 illustrates another example sub-band peak selection process, according to embodiments of the present disclosure. In this embodiment, the process takes one sample bin at a time as input and updates the peaks. The process begins by initializing peak value buffers and peak index buffers for each of the required peaks (e.g. three buffers for three peaks). The top of the buffer has the current peaks, while the bottom has the older values. In this example, the size of the buffer is equal to half of the guard band (HGB), and P₁>P₂>P₃.

For each sample the new input magnitude is compared with the current peaks. If the new input is less than all three peaks, nothing is done. For a case where the new input is less than P₁ and P₂, but greater than P₃, if the new value is outside the guard band for P₁ or P₂, the top of the buffer for P₃ is updated with the new input. For a case where the new input is less than P₁, but greater than P₂ and P₃, if the new value is outside the guard band of P₁, the top of the buffer for P₂ is updated with the new input, and the top of the buffer for P₃ is updated with the bottom of P₂. For a case where the new input is greater than all three peaks, the top of the buffer for P₁ is updated with the new input, the top of the buffer for P₂ is updated with the bottom of P₁, and the top of the buffer for P₃ is updated with the bottom of P₂. The buffers are then pushed down by one sample, and another input can be analyzed.

According to the processes disclosed in FIG. 16, additional memory savings can be achieved. For example, for picking P peaks from a total of N bins, and for a guard band size of G, only 2P*G/2=PG memory buffers may be needed. In contrast, for a full-band process the full number of N bins needs to be stored. This provides a memory savings of N−PG. In an example where three peaks are selected (P=3), six half guard bands (HGB) or three full guard bands (FGB) of locations in memory are used as a buffer. If N=1024 and G=16, the process disclosed in FIG. 16 would require a memory of 3*16=48. This provides a memory savings of 1024−48=976.

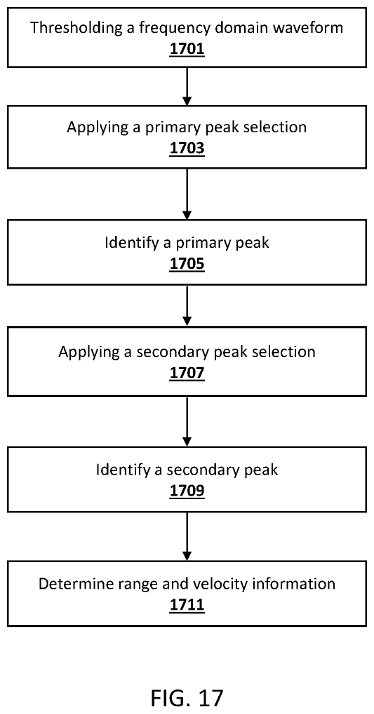

FIG. 17 is a flow diagram of an example method to select multiple peaks within a LIDAR system, according to an embodiment of the present disclosure. The method begins at operation 1701 with thresholding a frequency domain waveform. As discussed above, the thresholding can be performed by applying a SNR threshold value, intensity threshold value, or some other type of threshold value.

At operation 1703 primary peak selection is applied to the frequencies that pass the thresholding operation at 1701. The peak selection can be based on SNR values, intensity values, or other metrics in other embodiments.

At operation 1705, a primary peak is identified based on the primary peak selection.

At operation 1707, a secondary peak selection is applied. The secondary peak selection can be based on SNR values, intensity values, or other metrics, and can be applied to frequencies outside of a guard band of the primary peak identified at operation 1705.

At operation 1709, a secondary peak is identified based on the secondary peak selection. A secondary peak can be identified based on the highest intensity peak outside of the primary peak, the lowest frequency peak outside of the primary peak, or the highest intensity peak outside of the primary peak, in various embodiments.

At operation 1711, range and velocity information is determined for each of the peaks detected. Each of the peaks identified corresponds to a target or object. Thus, the techniques disclosed herein allow the system to determine range and velocity information (as well as other information such as reflectivity, etc.) for a number of targets or objects. In some embodiments, the range and velocity information can be fed into a point cloud.

In some embodiments, where more than two peaks are desired, the process can continue applying the same or different peak selection techniques in order to identify additional peaks, as discussed above. Thus, the techniques disclosed herein can be used to detect multiple targets, and to determine range and velocity data for any number of targets. The range and velocity data for each target can be fed into a point cloud, in some embodiments.

The various operations and methods described in the present application can be performed, in some embodiments, using the signal processing unit 112, signal conversion unit 106, or the signal conditioning unit 107 described above in FIG. 1. The various optical components, fiber delays, and other structural components can be implemented as the optical circuits 101 described in FIG. 1.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

The term “coupled,” along with its derivatives, is used to indicate that two or more elements interact with each other. These coupled elements may or may not be in direct physical or electrical contact with each other.

Although the operations of the methods herein are shown and described in a particular order, the order of the operations of each method may be altered so that certain operations may be performed in an inverse order or so that certain operation may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A light detection and ranging (LIDAR) system comprising:
an optical beam source to transmit a first optical beam to a target;
a photo detector to receive a return from the target; and
signal processing circuitry to:
threshold a frequency domain waveform to identify a plurality of peaks above a threshold level corresponding to a plurality of targets;
apply a primary peak selection to the frequency domain waveform to identify a primary peak from the plurality of peaks;
apply a secondary peak selection to a portion of the frequency domain waveform outside a guard-band area to identify a secondary peak from the plurality of peaks that is outside the guard-band area; and
determine range and velocity information corresponding to the primary peak and secondary peak.

2. The system of claim 1, wherein thresholding the frequency domain waveform includes applying a signal-to-noise ratio threshold, and applying the primary and secondary peak selection includes applying an intensity threshold.

3. The system of claim 1, wherein the guard-band area is a fixed frequency area around the primary peak in the frequency domain waveform.

4. The system of claim 1, wherein applying the secondary peak selection includes identifying a secondary peak that falls within the guard-band area but above an expected peak roll-off value, and the expected peak roll-off value is a distribution based on an intensity and a frequency of the primary peak.

5. The system of claim 1, wherein applying the secondary peak selection includes selecting a highest intensity peak, a highest frequency peak, or a lowest frequency peak of the plurality of peaks that is outside the guard-band area.

6. The system of claim 1, wherein the signal processing circuitry is further configured to:
divide the frequency domain waveform into a plurality of segments;
threshold each of the plurality of segments;
apply a primary peak selection and a secondary peak selection to a maximum value of each of the plurality of segments.

7. The system of claim 1, wherein the signal processing circuitry is further configured to:
divide the frequency domain waveform into a plurality of sub-bands;
threshold a first sub-band of the plurality of sub-bands to identify a plurality of peaks above a threshold level;
perform a first pass through the first sub-band to apply the primary peak selection and determine a first sub-band primary peak from the plurality of peaks;
perform a second pass through the first sub-band to apply the secondary peak selection and determine a first sub-band secondary peak from the plurality of peaks; and
perform thresholding, primary peak selection, and secondary peak selection to remaining sub-bands of the plurality of sub-bands to determine all peaks with a single pass through the frequency domain waveform.

8. The system of claim 7, wherein the signal processing circuitry is further configured to:
store the first sub-band primary peak and the first sub-band secondary peak in memory;
store all of the plurality of peaks above the threshold level from the first sub-band within two guard-bands of a second sub-band in memory;
perform thresholding, primary peak selection, and secondary peak selection to the second sub-band to identify a second sub-band primary peak and a second sub-band secondary peak; and
compare the first sub-band primary peak, the first sub-band secondary peak, the second sub-band primary peak, and the second sub-band secondary peak to determine a new primary peak and a new secondary peak for the first and second sub-band.

9. The system of claim 1, wherein the signal processing circuitry is further configured to:
store the primary peak and secondary peak in a peak value buffer in memory;
analyze a new input of the frequency domain waveform to identify a new peak above the threshold level;
if the new peak has a value greater than the primary and secondary peak and is outside the guard band area for the primary and secondary peaks, update the peak value buffer with the new peak as the new primary peak;
if the new peak has a value greater than the secondary peak but less than the primary peak and is outside the guard band area for the primary and secondary peaks, update the peak value buffer with the new peak as the new secondary peak; and
if the new peak has a value less than the primary and secondary peaks and is outside the guard band area for the primary and secondary peaks, update the peak value buffer with the new peak as a third peak.

10. A method of selecting multiple returns in a light detection and ranging (LIDAR) system, the method comprising:
thresholding a frequency domain waveform to identify a plurality of peaks above a threshold level corresponding to a plurality of targets;
applying a primary peak selection to the frequency domain waveform to identify a primary peak from the plurality of peaks;
applying a secondary peak selection to a portion of the frequency domain waveform outside a guard-band area to identify a secondary peak from the plurality of peaks that is outside the guard-band area; and
determining range and velocity information corresponding to the primary peak and secondary peak.

11. The method of claim 10, wherein thresholding the frequency domain waveform includes applying a signal-to-noise ratio threshold, and applying the primary and secondary peak selection includes applying an intensity threshold.

12. The method of claim 10, wherein the guard-band area is a fixed frequency area around the primary peak in the frequency domain waveform.

13. The method of claim 10, wherein applying the secondary peak selection includes identifying a secondary peak that falls within the guard-band area but above an expected peak roll-off value, and the expected peak roll-off value is a distribution based on an intensity and a frequency of the primary peak.

14. The method of claim 10, wherein applying the secondary peak selection includes selecting a highest intensity peak, a highest frequency peak, or a lowest frequency peak of the plurality of peaks that is outside the guard-band area.

15. The method of claim 10, further comprising:
dividing the frequency domain waveform into a plurality of segments;
thresholding each of the plurality of segments;
applying a primary peak selection and a secondary peak selection to a maximum value of each of the plurality of segments.

16. The method of claim 10, further comprising:
dividing the frequency domain waveform into a plurality of sub-bands;
thresholding a first sub-band of the plurality of sub-bands to identify a plurality of peaks above a threshold level;
performing a first pass through the first sub-band to apply the primary peak selection and determine a first sub-band primary peak from the plurality of peaks;
performing a second pass through the first sub-band to apply the secondary peak selection and determine a first sub-band secondary peak from the plurality of peaks; and
performing thresholding, primary peak selection, and secondary peak selection to remaining sub-bands of the plurality of sub-bands to determine all peaks with a single pass through the frequency domain waveform.

17. The method of claim 16, further comprising:
storing the first sub-band primary peak and the first sub-band secondary peak in memory;
storing all of the plurality of peaks above the threshold level from the first sub-band within two guard-bands of a second sub-band in memory;
performing thresholding, primary peak selection, and secondary peak selection to the second sub-band to identify a second sub-band primary peak and a second sub-band secondary peak; and
comparing the first sub-band primary peak, the first sub-band secondary peak, the second sub-band primary peak, and the second sub-band secondary peak to determine a new primary peak and a new secondary peak for the first and second sub-band.

18. The method of claim 10, further comprising:
storing the primary peak and secondary peak in a peak value buffer in memory;
analyzing a new input of the frequency domain waveform to identify a new peak above the threshold level;
if the new peak has a value greater than the primary and secondary peak and is outside the guard band area for the primary and secondary peaks, updating the peak value buffer with the new peak as the new primary peak;
if the new peak has a value greater than the secondary peak but less than the primary peak and is outside the guard band area for the primary and secondary peaks, updating the peak value buffer with the new peak as the new secondary peak; and
if the new peak has a value less than the primary and secondary peaks and is outside the guard band area for the primary and secondary peaks, updating the peak value buffer with the new peak as a third peak.

19. A light detection and ranging (LIDAR) system comprising:
an optical beam source to transmit a first optical beam to a target;
a photo detector to receive a return from the target; and
signal processing circuitry including a memory storing instructions which, when executed, cause the signal processing circuitry to:
threshold a frequency domain waveform to identify a plurality of peaks above a threshold level corresponding to a plurality of targets;
apply a primary peak selection to the frequency domain waveform to identify a primary peak from the plurality of peaks;
apply a secondary peak selection to a portion of the frequency domain waveform outside a guard-band area to identify a secondary peak from the plurality of peaks that is outside the guard-band area;
determine range and velocity information corresponding to the primary peak and secondary peak; and
feed the range and velocity information to a point cloud.

20. The system of claim 19, wherein thresholding the frequency domain waveform includes applying a signal-to-noise ratio threshold, and applying the primary and secondary peak selection includes applying an intensity threshold.
